(19) United States
(12) Patent Application Publication
(10) Pub. No.: US 2004/0088230 A1
(43) Pub. Date: May 6, 2004

(54) Method to detect fraudulent return of merchandise

(76) Inventors: Timothy J. Elliott, East Dubuque, IL (US); Candie A. Elliott, East Dubuque, IL (US)

Correspondence Address: ZARLEY LAW FIRM P.L.C., CAPITAL SQUARE, 400 LOCUST, SUITE 200, DES MOINES, IA, 50309-2350, US

(21) Appl. No.: 10/289,015

(22) Filed: Nov. 6, 2002

(51) Int. Cl. G06F 17/60

(52) U.S. Cl. 705/28

(57) ABSTRACT

A method to detect fraudulent return of merchandise includes the steps of taking a plurality of identical goods and locating the goods at one or more purchasing locations; placing different indicia on the goods wherein each indicia is unique to each single item of goods; generating a sales slip at a purchasing station wherein the indicia for each item of goods purchased is printed thereon; providing a returned goods station whereby a purchaser can return a previously purchased item of goods accompanied by the sales slip; and comparing the unique indicia on the item of goods being returned with the unique indicia appearing on the sales slip to determine that the unique indicia on goods being returned is identical to the unique indicia appearing on the sales slip to insure that the item of goods being returned is the same item whose purchase was reflected by the sales slip.

### BACKGROUND OF THE INVENTION

A common but relatively unnoticed crime is accomplished primarily in retail stores and the like wherein a customer takes one of a plurality of identical products from a location within a store; pays for the product and obtains a sales slip; exits the store and returns to the store the next day with the sales slip; takes a second one of the identical products; presents the second product to a clerk at the return station in the store; presents the old sales ticket and the second product to the clerk for return of the second product; receives the purchase price on the sales ticket in exchange for the sales ticket and the second product; and exits the store with the returned cash. This same scheme obviously can take place in a variety of environments, but the end result is always the same because the retailer is unaware that it is receiving and paying for a product that has never been sold.

It is therefore a principal object of this invention to provide a method to detect fraudulent return of merchandise.

A further object of this invention is to provide a method to detect fraudulent return of merchandise that will enable a return clerk to immediately confirm that an item submitted for return is precisely the identical item that was the subject of the sale reflected on the original sales slip.

A still further object of this invention is to provide a method to detect fraudulent return of merchandise which can be easily employed and inexpensively and quickly implemented by both the check out clerks and the persons attending to the return counters.

These and other objects will be apparent to those skilled in the art.

### SUMMARY OF THE INVENTION

A method to detect the fraudulent return of merchandise includes taking a plurality of identical goods and locating the goods at one or more purchasing locations; placing different indicia on the goods wherein each indicia is unique to each single item of goods; generating a sales slip at a purchasing station wherein the indicia for each item of goods purchased is printed thereon; providing a returned goods station whereby a purchaser can return a previously purchased item of goods accompanied by the sales slip; comparing the unique indicia on the item of goods being returned with the unique indicia appearing on the sales slip to determine that the unique indicia on goods being returned is identical to the unique indicia appearing on the sales slip to insure that the item of goods being returned is the same item whose purchase was reflected by the sales slip.

### BRIEF DESCRIPTION OF THE DRAWING

FIG. 1 is a schematic drawing showing the steps of how the invention is practiced.

### DESCRIPTION OF THE PREFERRED EMBODIMENTS

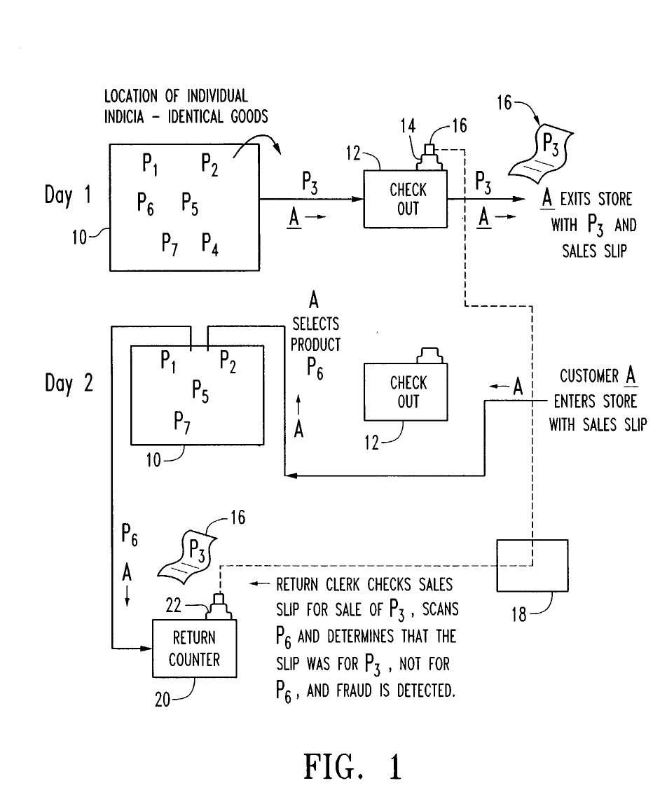

This invention and the method thereof is shown graphically in FIG. 1. A plurality of identical goods or products designated by the letter “P” are located in shelf or container 10. Each product “P” has an individual unique indicia mark thereon, e.g. P₁, P₂, P₃, etc. with the numerals 1, 2, 3, etc. serving to act as the unique indicia mark. This can be incorporated into conventional bar codes that are on the product, or by any other means, including serial numbers or the like. They can be placed thereon by the manufacturer by pre-arrangement, or placed thereon by the vendor when the products P are located at 10.

The numeral 12 designates a conventional check out station having a check-out register 14 capable of generating a sales slip 16. A conventional scanning device (not shown) scans the bar code on the product which identifies the specific product being checked out and includes this information on the sales slip 16 including the unique indicia mark on the product being purchased. The register 12 is conventionally connected to computer 18 for inventory control and other purposes.

A product return counter or station 20 also has a register 22 which is connected to computer 18 to enable register 22 to access the computer 18 as may be desired. A scanner (not shown) is also employed at register 22.

A customer A selects a product P₃ from station 10, and conventionally checks out at station 12 wherein a sales slip P₃ is generated thereon. If the customer A later returns to the store and seeks to return the product P₃ with the accompanying sales slip 16, the clerk will scan the bar code or the like on the product P₃ which will then confirm that the returned product P₃ is in fact the product P₃ appearing upon the original sales slip 16.

However, if the customer leaves the premises on the date of purchase with product P₃, and later returns to the store with only the sales slip 16, and then takes product P₆ from location 10, and proceeds to the return station 20, the clerk at station 20 will scan the product P₆ and will compare it with the sales slip 16, whereupon the clerk will immediately recognize that while product P₃ was purchased, the customer is attempting to return a different product P₆, whereupon the attempted fraudulent return of merchandise will be discovered.

This invention will serve to end millions of dollars of fraudulently returned merchandise. It can be easily implemented and easily employed by many types of businesses. It is therefore seen that this invention will achieve at least all its stated objectives.

What is claimed is:

1. A method to detect fraudulent return of merchandise, comprising,
taking a plurality of identical goods and locating the goods at one or more purchasing locations,
placing different indicia on the goods wherein each indicia is unique to each single item of goods,
generating a sales slip at a purchasing station wherein the indicia for each item of goods purchased is printed thereon,
providing a returned goods station whereby a purchaser can return a previously purchased item of goods accompanied by the sales slip, and
comparing the unique indicia on the item of goods being returned with the unique indicia appearing on the sales slip to determine that the unique indicia on goods being returned is identical to the unique indicia appearing on the sales slip to insure that the item of goods being returned is the same item whose purchase was reflected by the sales slip.

2. The method of claim 1 wherein the indicia is a bar code.

3. The method of claim 1 wherein the unique indicia on the goods at both the purchasing station and the returned goods station is determined by electronic scanning.

4. The method of claim 2 wherein the unique indicia on the goods at both the purchasing station and the returned goods station is determined by electronic scanning.
